(19) United States
(12) Patent Application Publication
(10) Pub. No.: US 2012/0067746 A1
(43) Pub. Date: Mar. 22, 2012

(54) TAMPERPROOF CASE

(75) Inventors: Frederic GREMAUD, Epagny (CH); Xavier SCHWAB, Prilly (CH); Eric DECOUX, Matran (CH)

(73) Assignee: SICPA HOLDING SA, Prilly (CH)

(21) Appl. No.: 13/234,633

(22) Filed: Sep. 16, 2011

Related U.S. Application Data
(60) Provisional application No. 61/384,047, filed on Sep. 17, 2010.

(30) Foreign Application Priority Data
Sep. 17, 2010 (EP) PCT/EP2010/063752

(51) Int. Cl. A45C 1/00; B65B 5/02; A45C 11/00; B65D 71/00; B42D 15/00; B65D 90/02

(52) U.S. Cl. 206/81; 206/82; 283/85; 206/524.6; 206/6.1; 206/232; 53/452

(57) ABSTRACT

A tamperproof case for a genuine article which comprises a space for accommodating the article between first and second sheet members which are capable of being permanently bonded together in at least the area that substantially completely surrounds the space. At least one of the first and second sheet members comprises at least one security element that is invisible under light in the visible wavelength range. This abstract is neither intended to define the invention disclosed in this specification nor intended to limit the scope of the invention in any way.

### CROSS-REFERENCE TO RELATED APPLICATIONS

The present application claims the benefit under 35 U.S.C. §119(e) of U.S. Provisional Application No. 61/384,047, filed Sep. 17, 2010 and claims priority under 35 U.S.C. §119 of International Patent Application No. PCT/EP2010/063752, filed Sep. 17, 2010. The entire disclosures of these applications are expressly incorporated by reference herein.

### BACKGROUND OF THE INVENTION

1. Field of the Invention

The present invention relates to tamperproof case for a genuine article such as an article of value and in particular, a tamperproof case which comprises at least one security element. The present invention also relates to a method of making the tamperproof case and to a method of authenticating a genuine article by using the tamperproof case.

2. Discussion of Background Information

Many countries around the world have a National or Commemorative day. Often this day is an occasion for governments, public organizations or private companies to issue a special item in the form of an article of value such as a stamp, a coin, a banknote etc. Frequently the special item is provided in a case which can be given as a present or can be purchased by a collector. Further, in some countries especially in Africa a case which contains, for example, a gold coin represents not only a collectible item but is used as an instrument of payment that sometimes is more reliable and thus, preferable than a local currency which may be subject to (high) inflation.

Since for the above and other reasons many cases containing an article of value are in circulation there is a high temptation for counterfeiters to replace an encased coin of precious metal or other article of value inside a case with a counterfeit article of value in a reproduced case that looks like the original case and to sell the encased counterfeit article to unsuspecting consumers. Similar situations occur with other genuine articles of value such as a coin (made of, e.g., a precious metal such as gold, platinum, or silver), a medal, an ingot, a gem, a diamond, a pearl, jewelry, a watch, a stamp, a banknote, or an antique or ancient article (e.g. an ancient document) or article sold on the market such as, e.g., software, CDs/DVDs, computer parts (e.g. chips, microprocessors, etc.), spare parts for automobiles and appliances, a foodstuff, perfume, cosmetics and pharmaceuticals.

Several solutions for avoiding such counterfeiting have been proposed to date such as, for example placing a certificate of authenticity inside a case containing an article of value. Such certificates have been extensively copied by counterfeiters because very often the certificate can be reproduced by modern printing techniques which are in some cases capable of affording a certificate that is virtually identical to the original.

U.S. Pat. No. 5,042,650, the entire disclosure of which is incorporated by reference herein, discloses a tamperproof coin case defined by two interlocking plastic plate members which are ultrasonically bonded together to define a unitary assembly within which a coin and a certificate of authenticity may be permanently secured. One plate member includes a cavity for fully receiving the other plate member therein, with opposing inner surfaces of the plate members being provided with corresponding cylindrical recesses which collectively form a cylindrical cavity within which a pliable plastic retention ring is disposed for securing the coin in a stationary position and permitting its obverse and reverse sides to be viewed through dome-shaped windows provided on the opposite sides of the case. A main drawback of this case is the possibility for a counterfeiter to break one of the plastic plates, to replace the original coin with a fake one and to use a new plate to recreate the original case which contains a fake coin in a case which looks like the original case.

European patent application EP0345405, the entire disclosure of which is incorporated by reference herein, discloses a case of plastic material for a single marketable valuable piece such as a coin, a medal, a precious stone, a pearl, a stamp, etc., made of two superimposed elements that are connected at least all along their edges, at least one of these elements being transparent and formed with a shell to lodge said piece. The upper and lower elements are shaped as credit cards and enclose the piece with certification data. Further, in order to provide a seal not only against counterfeiting but also against forced opening, the case comprises a delaminable security printing pattern in the form of a hologram or of a multi-ink layer which is anchored in a discontinuous way and gets visibly and irreparably lacerated as soon as an opening attempt is made on the case. A main drawback of this assembly is the possibility to reproduce in the transparent lower element the indelible graphic pattern which is in the form of decorative imprints and thereby create a fake case. Further, technologies for making holograms are well known and holograms are extensively reproduced around the world.

In view of the foregoing, there is a need to overcome the drawbacks of the prior art and to provide a tamperproof case for genuine articles such as articles of value which provides a high level of security and makes a faithful reproduction thereof difficult, if not impossible and which can further be tracked and traced from its production to the market where it is sold.

### SUMMARY OF THE INVENTION

The present invention provides a tamperproof case that contains a genuine article. The case comprises a space (e.g. a cavity or shell) that contains the article between two sheet members (first and second sheet members) which are permanently bonded together in at least an area or zone that substantially completely surrounds the space. At least one of the two sheet members comprises at least one security element that is invisible under light in the visible wavelength range, and/or at least one security element that is invisible under light in the visible wavelength range is present in the area or zone in which the two sheet members are permanently bonded together.

In one aspect of the tamperproof case, at least one security element that is invisible under light in the visible wavelength range may be present in the area surrounding the article in which the two sheet members are permanently bonded together.

In another aspect of the case, at least one security element that is invisible under light in the visible wavelength range may be present on and/or inside at least one of the two sheet members.

In a still further aspect, the case may comprise at least two (e.g., two, three, four or more) security elements which are invisible under light in the visible wavelength range. Further, at least one of these security elements may be present in the area in which the two sheet members are permanently bonded together (and preferably in an area which substantially completely surrounds the article).

In another aspect of the case of the present invention, the at least one security element may be visible under UV light (and/or under IR light) and at least one of the two sheet members may be made of a material that is transparent for UV light (and/or for IR light) in at least the area that comprises the security element. For example, the material may comprise a thermoplastic resin such as one or more of an acrylic resin, a methacrylic resin (e.g., polymethyl methacrylate), polyvinyl chloride, and a polycarbonate. The material may also comprise a molded resin.

In another aspect of the case of the present invention, the two sheet members may have been permanently bonded together by at least one of ultrasonic welding, laser welding, lamination, crimping, and gluing.

In yet another aspect, the at least one security element may comprise one or more of a flake, a dye, a crystal, a polymer, a polymorph, an organic compound, an inorganic compound, a complex compound, a chelate compound, a salt, and nanoparticles.

In another aspect, the at least one security element may have been applied in the form of an ink (e.g., a printing ink).

In another aspect of the case of the tamperproof case of the present invention, the at least one security element may be present as at least one of a data matrix, a logo, a character, a barcode, a motif, a pattern, and an indicia.

In another aspect, the genuine article may be or comprise at least one of an article of value such as a coin (made of, e.g., a precious metal such as gold, platinum, or silver), a medal, an ingot, a gem, a diamond, a pearl, jewelry, a watch, a stamp, a banknote, an antique or ancient article (e.g. an ancient document), and/or it may be or comprise an article sold on the market such as, e.g., a foodstuff, a perfume, a cosmetic product, a pharmaceutical, a software storage medium, a computer part, a CD or DVD, or a spare part for an automobile or an appliance.

In a still further aspect of the tamperproof case, a certificate of authenticity may be present between the two sheet members. For example, the certificate of authenticity may be present as a (third) sheet member. Also, the certificate of authenticity (which may comprise at least one security element that is invisible under light in the visible wavelength range) may comprise a void (e.g., a hole) and the article may be at least partially surrounded by the certificate. Further, the certificate may be permanently bonded to the first and second sheet members in at least a part of the area in which the first and second sheet members are permanently bonded together and in particular in cases where the certificate comprises at least one security element that is invisible under light in the visible wavelength range, the at least one security element may be present in the area in which the certificate is permanently bonded to the first and second sheet members.

The present invention also provides a tamperproof case for a genuine article. The case comprises a space (e.g., a cavity) for accommodating the (optionally packaged) article between two (first and second) sheet members which are capable of being permanently bonded together in at least an area that substantially completely surrounds the space. Further, at least one of the two sheet members comprises at least one security element that is invisible under light in a visible wavelength range.

In one aspect of the tamperproof case, the two sheet members may comprise at least two security elements that are invisible under light in a visible wavelength range. For example, each of the two sheet members may comprise at least one of the at least two security elements.

The present invention also provides a method of making a tamperproof case for a genuine article and the tamperproof case obtainable thereby. The method comprises permanently bonding together two sheet members which together provide a space (e.g. a cavity) for accommodating the article between the sheet members. The bonding of the sheet members is conducted to not more than an extent which still allows the article of value to be placed in the space. Further, at least one of the two sheet members comprises at least one security element that is invisible under light in the visible wavelength range.

In one aspect of the method, the at least one security element may be present in an area where the first and second sheet members have been permanently bonded together.

The present invention further provides a method of authenticating a genuine article. The method comprises arranging the article in a space between two sheet members, and permanently bonding the two sheet members together in at least an area that substantially completely surrounds the space that contains the article. Further, at least one of the two sheet members comprises at least one security element that is invisible under light in the visible wavelength range.

In one aspect of the method, the at least one security element may be present in the area that substantially completely surrounds the space containing the article where the two sheet members have been permanently bonded together.

In another aspect, the method may further comprise placing a certificate of authenticity between the two sheet members. For example, the certificate of authenticity may be present as a (third) sheet member and/or may comprise a void and the article of value may be arranged so that at least a part of the article of value is present in the void. Further, the certificate of authenticity may comprise at least one security element that is invisible under light in the visible wavelength range and/or may be permanently bonded to the first and second sheet members.

The present invention also provides a tamperproof bag that contains a genuine article. The bag is permanently sealed and comprises at least one security element that is invisible under light in the visible wavelength range.

In one aspect of the bag, the at least one security element may be present in an area in which the opening of the bag is permanently sealed.

In another aspect, the at least one security element may be present inside a material from which the bag is made (e.g., incorporated in the material during the production thereof).

In yet another aspect, the bag may have been permanently sealed by at least one of ultrasonic welding, laser welding, lamination, crimping, and gluing.

The present invention also provides a tamperproof bag for a genuine article. The bag comprises a single opening that is capable of being permanently sealed, and the bag further comprises at least one security element that is invisible under light in the visible wavelength range.

In one aspect, the bag may comprise at least two security elements that are invisible under light in the visible wavelength range.

The present invention also provides a method of authenticating a genuine article and an authenticated genuine article obtainable thereby. The method comprises placing the article in a bag and permanently sealing the bag. The bag comprises at least one security element that is invisible under light in the visible wavelength range.

### BRIEF DESCRIPTION OF THE DRAWINGS

The present invention is further described in the detailed description which follows, in reference to the plurality of drawings by way of non-limiting examples of exemplary embodiments of the present invention, and wherein:

FIG. 1 is an exploded view of one embodiment of a tamperproof case of the present invention that contains a genuine article and a certificate of authenticity;

FIG. 2a shows a top view of the tamperproof case of FIG. 1;

FIG. 2b shows a side view of the tamperproof case of FIG. 1;

FIG. 3a shows parts of the first and second sheet members and the certificate of authenticity of the case of FIG. 1 before permanent bonding of the first and second sheet members; and

FIG. 3b a shows parts of the first and second sheet members and the certificate of authenticity of the case of FIG. 1 after permanent bonding of the first and second sheet members.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The tamperproof case of the present invention is constituted by at least two parts, i.e., a first sheet member and a second sheet member. While these sheet members will frequently be made of or comprise a thermoplastic material and in particular, a transparent thermoplastic material, they may also be made of or comprise other materials such as, e.g., glass, paper, cardboard, metal, a molded resin, or composite materials. Preferably, at least one of the sheet members is made of or comprises a thermoplastic resin. Non-limiting examples of thermoplastic resins which are suitable as materials for making the sheet members for use in the present invention include acrylic resins, methacrylic resins (in particular, polymethyl methacrylate), polyvinyl chloride, polycarbonates, polysulfones, polyesters (e.g., polyethylene terephthalate), polyethers, polyamides, polyurethanes, polyvinylacetate, polystyrene, and polyolefins (e.g., polyethylene and polypropylene). The first and second sheet members may be made from identical or different material(s). They can be made by any suitable method such as, e.g., casting, extrusion, molding, etc. (depending on the material).

At least one of the first and second sheet members preferably is transparent in its entirety or transparent at least in an area which includes at least a part of the space (and preferably the entire space) that contains the genuine article so that a consumer can view the article from the outside of the case (e.g., without having to rely on information regarding the contents of the case which may have been provided on one of the sheet members or on an item such as a label connected thereto). One of the first and second sheet members will often be opaque either in portions thereof or in its entirety (e.g., a bottom sheet member in order to provide a better contrast to the genuine article and enhance the visibility thereof). Even if this sheet member is made of a transparent material it can be coated on one or both sides with a composition (paint or ink) which renders the sheet member opaque and/or colored, and/or a pigment and the like can be added to (dispersed or dissolved in) the material for making the sheet member.

At least one of the sheet members (and preferably both sheet members) are substantially transparent for light under which the one or more security elements which are invisible under light in the visible wavelength range (hereinafter sometimes referred to as “invisible security element”) are visible, at least in the area(s) in which the invisible security element(s) is/are visible to make it possible to make the invisible security element(s) visible when using a suitable device. The light under which the invisible security elements are visible will often comprise light in the UV range and/or in the IR range.

The thickness of the first and second sheet members for use in the present invention is not critical and depends, inter alia, on the material from which the sheet member is made, the degree of protection of the genuine article from physical, chemical and other attacks that is to be provided by the case, the size of the article, etc. The thickness of the sheet members will often be in a range of from about 10 μm to about 5 mm, e.g., from about 0.1 to about 2 mm, from about 0.5 to about 1 mm, or from about 1 mm to 5 about mm. Also, the first and second sheet members will usually be of substantially the same size and shape (e.g., rectangular, square, circular, etc.), although it is possible for one of the sheet members to be larger than the other sheet member and/or to be of a different shape than the other sheet member.

The space that is present between the first and second sheet members is at least large enough to accommodate the genuine article or, if the genuine article is present in packaged form (as will often be the case for software storage media, CDs, DVDs, pharmaceuticals, perfumes, cosmetics etc.), the packaged article, and can be larger than the (packaged) article.

Often the space for accommodating the genuine article will be present in the form of a void or shell that is provided by (in) one of the first and second sheet members (the other sheet member being substantially flat), or by both sheet members together (to the same or a different extent). However, especially for two-dimensional articles such as, e.g., a stamp or a banknote no separate void at all has to be provided and the article may merely be placed between two substantially flat sheet members, whereafter the sheet members can be permanently bonded together at least in an area or zone which substantially completely surrounds the article.

The area or zone which substantially completely surrounds the space that contains the article of value may comprise the perimeter of the first and second sheet members but can alternatively (or additionally) be, for example, an area or zone which is immediately adjacent to the article or the space containing the article, respectively. The width of the area in which the sheet members are permanently bonded together may vary across the case but should in any event always be large enough to ensure a secure seal which can only be broken by causing visible damage to the seal and/or the two sheet members. A suitable minimum width of the area is about 0.5 mm, e.g., at least about 1 mm, at least about 2 mm, at least about 0.5 cm, or at least about 1 cm. While not critical, the largest width of the area or zone in which the two sheet members are permanently bonded together will usually be not larger than about 5 cm, e.g., not larger than about 2 cm.

In this regard, it is noted that the phrase “substantially completely surrounds” is to indicate that the area in which the first and second sheet members are permanently bonded together and which surrounds the space containing the genuine article may comprise one or more gaps where the sheet members are not, or at least not permanently, bonded together. However, none of these gaps, if any, will be large enough to allow one to pull or otherwise remove the article from the space between the first and second sheet members without visibly damaging the sheet members and/or the permanent bond between them.

It further is to be appreciated that the present invention is not limited to a tamperproof case which comprises a single space containing a single genuine article. Rather, the tamperproof case may contain several genuine articles (e.g., several pearls) in a single space (e.g., a single void) and/or the tamperproof case may comprise two or more (e.g., three, four or more) spaces, all of which contain at least one genuine article. If more spaces are present, the spaces may be of the same size or of a different size. If more than one genuine article is present, the articles may be identical or different. Merely by way of example, a tamperproof case of the present invention may contain a set of say, four gold coins (of the same size or of a different size), each of which is contained in a separate space provided by the case. Each of these four spaces may individually be substantially completely surrounded by an area in which the first and second sheet members are permanently bonded together. Alternatively, two or three, or all four of these spaces as a group may be substantially completely surrounded by a single area in which the first and second sheet members are permanently bonded together (e.g., along the entire perimeter of the sheet members).

The method by which the sheet members for making the tamperproof case of the present invention are permanently bonded together is not particularly limited, although the suitability of a given method may depend on the material(s) from which the first and second sheet members are made. Non-limiting examples of suitable methods include ultrasonic welding, laser welding, lamination, crimping, and gluing. Especially in the case of sheet members made of thermoplastic resins ultrasonic welding will often be the method of choice. It is, of course, also possible to use a combination of two or more different methods.

The one or more invisible security elements of the tamperproof case of the present invention may be present anywhere on and/or inside the first and second sheet members. If two or more invisible security elements are present, they may be the same or different. For example, they may be made of the same material or of a different material (for example, one may be visible (only) under UV light and the other one may be visible (only) under IR light) and/or they may be in the same faun or in a different form. Also, if two or more invisible security elements are present they may be present on and/or inside the same sheet member or on and/or inside both sheet members, preferably both sheet members. If two or more security elements are present inside and/or on both sheet members they may be identical or different (preferably different). The presence of at least two invisible security elements in two different locations of the tamperproof case is preferred. It may further be possible for the security element to be present across (inside) an entire sheet member, for example, by incorporating (e.g. uniformly dissolving or dispersing), e.g., a fluorescent compound in a material such as, e.g., a thermoplastic resin from which a sheet member is made.

According to the present invention it is preferred for at least one invisible security element to be present in the area wherein the sheet members are permanently bonded together and which substantially completely surrounds a space that contains a genuine article. This strengthens the security provided by the tamperproof case in that forced (partial) separation of the two sheet members may compromise the invisible security element (without making the perpetrator aware of the (invisible) damage caused) even if the damage to the sheet members and the permanent bond is virtually unnoticeable. It is even more preferred for two or more invisible security elements to be present in two or more different locations of this area.

An invisible security element for use in the present invention may take various forms. For example, it may be present in the form of at least one of a flake, an (organic or inorganic) dye, a crystal, a polymer, a polymorph, an organic compound, an inorganic compound, a complex compound, a chelate compound, an (inorganic or organic) salt, and nanoparticles. The material from which the invisible security element is made should be substantially invisible under light inside the visible spectrum but visible under light outside the visible spectrum such as UV or IR light. Of course, the material for making the invisible security element must also be compatible with the material(s) for the sheet members and preferably also with the method by which the sheet members are permanently bonded together (e.g., should be able to withstand elevated temperatures encountered in, e.g., laser welding or ultrasonic welding). Corresponding materials are well known to those of skill in the art and include, for example, salts and/or complexes of rare earth metals (scandium, yttrium and the lanthanides such as Ce, Pr, Nd, Sm, Eu, Gd, Tb, Dy, Ho, Er, Tm, and Yb) and the actinides. Specific and non-limiting examples of corresponding materials include chelates of at least one of europium, ytterbium, and terbium with at least one of dipicolinic acid, 4-hydroxy-2,6-pyridinedicarboxylic acid, 4-amino-2,6-pyridinedicarboxylic acid, 4-ethoxy-2,6-pyridinedicarboxylic acid, 4-isopropoxy-2,6-pyridinedicarboxylic acid, and 4-methoxy-2,6-pyridinedicarboxylic acid. Non-limiting examples of pigments that can be used in the present invention include those disclosed in WO 2008/000755, the entire disclosure of which is incorporated by reference herein. Non-limiting examples of IR absorber compounds for use in the present invention include those disclosed in WO2007/060133, the entire disclosure of which is incorporated by reference herein. Non-limiting examples of specific materials include copper(II) fluoride (CuF₂), copper hydroxyfluoride (CuFOH), copper hydroxide (Cu(OH)₂), copper phosphate hydrate (Cu₃(PO₄)₂*2H₂O), anhydrous copper phosphate (Cu₃(PO₄)₂), basic copper(II) phosphates (e.g. Cu₂PO₄(OH), “Libethenite” whose formula is sometimes written as Cu₃(PO₄) 2*Cu(OH)₂; Cu₃(PO₄)(OH)₃, “Cornetite”, Cu₅(PO₄)₃(OH)₄, “Pseudomalachite”, CuAl₆(PO₄)₄(OH)₈.5H₂O “Turquois (II) pyrophosphate (Cu₂(P₂O₇)*3H₂O), anhydrous copper(II) pyrophosphate (Cu₂ (P₂O₇)), copper(II) metaphosphate (Cu(PO₃)₂, more correctly written as Cu₃(P₃O₉)₂), iron(II) fluoride (FeF₂*4H₂O), anhydrous iron(II) fluoride (FeF₂), iron(II) phosphate (Fe₃(PO₄)₂*8H₂O, “Vivianite”), lithium iron(II) phosphate (LiFePO₄, “Triphylite”), sodium iron(II) phosphate (NaFePO₄, “Maricite”), iron(II) silicates (Fe₂SiO₄, “Fayalite”; FexMg₂xSiO₄, “Olivine”), iron(II) carbonate (FeCO₃, “Ankerite”, “Siderite”); nickel(II) phosphate (Ni₃(PO₄)₂*8H₂O), and titanium(III) metaphosphate (Ti(P₃O₉)). Moreover, a crystalline IR absorber may also be a mixed ionic compound, i.e., where two or more cations are participating in the crystal structure, as e.g. in Ca₂Fe(PO₄)₂*4H₂O, “Anapaite”. Similarly, two or more anions can participate in the structure as in the mentioned basic copper phosphates, where OH⁻ is the second anion, or even both together, as in magnesium iron phosphate fluoride, MgFe(PO₄)F, “Wagnerite”. Additional non-limiting examples of security elements for use in the present invention are disclosed in WO 2008/128714, the entire disclosure of which is incorporated by reference herein.

Exemplary wavelength ranges of light under which the invisible security element for use in the present invention should be detectable (e.g., by luminescence such as fluorescence) are the UV range from about 200 nm to about 400 nm and the IR range from about 780 nm to about 1200 nm and in particular, from about 780 nm to about 1000 nm.

The security element for use in the present invention may be applied in many different forms which may depend, at least in part, on the nature of the material from which the security element is made. For example, the security element can be applied in the form of a liquid (solution, dispersion, etc.), e.g., as droplets, a gel, or a solid (e.g. as a powder or in the form of flakes).

The form in which the security element of the present invention is present on and/or inside one or both of the sheet members is not critical and may comprise, for example, one or more of a data matrix, a logo, a character, a barcode, a motif, a pattern and an indicia. These forms may be provided by employing, for example, a (printing) ink which comprises the material for the invisible security element and a technique such as, e.g., inkjet-printing (continuous inkjet printing, drop-on-demand inkjet printing, etc.), flexography, gravure printing, offset printing, screen printing, knife coating, roller coating, screen coating, and curtain coating. Suitable concentrations of the material for the invisible security element in the ink and the like liquid that is used for applying the invisible security element are often from about 0.0001% to about 20%, e.g., from about 0.001% to about 15%, from about 0.01% to about 10%, or from about 0.1% to about 5% by weight, based on the total weight of the ink (the remainder of the ink comprising conventional components such as, e.g., solvent and the like).

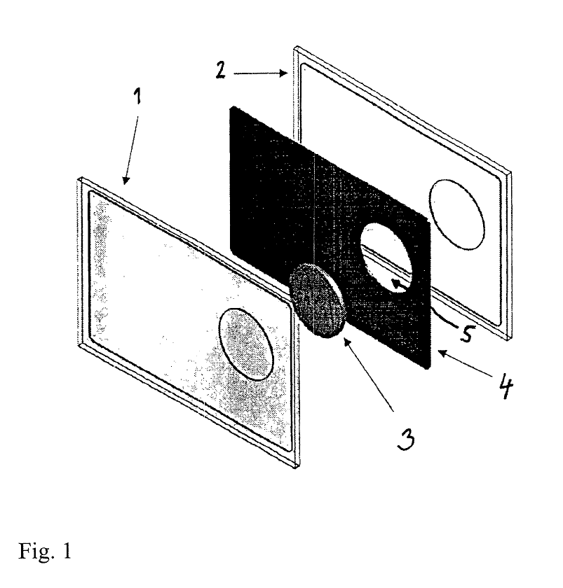

As set forth above, the tamperproof case of the present invention may further comprise a certificate of authenticity. The certificate will usually be in sheet form (e.g. rectangular) and will usually not be larger (and often smaller) than any of the two sheet members for making the tamperproof case of the present invention. The certificate can, for example, be present behind the genuine article, or at least a part of the genuine article such as, e.g., a coin may be at least partially surrounded by the certificate, as illustrated in FIG. 1. Further, in addition to the one or more invisible security elements that are present in and/or on the sheet members that constitute the tamperproof case the certificate may also comprise one or more invisible security elements which may be the same as, or different from, the security element(s) of the case. Further, it is possible for the genuine article itself and/or the packaging thereof (e.g., a (cardboard) box, a container such as a bottle, etc.) to comprise one or more invisible security elements which may be the same as, or different from, the security element(s) of the case and/or the certificate of authenticity (if present).

The certificate may further be permanently bonded to the first and second sheet members and in particular, in at least a part of the area (e.g., the perimeter) where the first and second sheet members are permanently bonded together. In other words, in this area the certificate is sandwiched between the sheet members. If the certificate comprises an invisible security element it is advantageous for this element to be present in the area where the security element is permanently bonded to the sheet members.

The tamperproof bag of the present invention is similar to the tamperproof case set forth above, wherefore the comments made above apply mutatis mutandis in this case as well. For example, the bag may be made of the same materials that are also useful for making the first and second sheet members as long as they are transparent for light under which the invisible security element(s) provided on or inside the material are visible. Furthermore, the bag may contain one or more genuine (optionally packaged) articles and may additionally contain at least one certificate of authenticity as set forth above. The opening of the bag can be sealed by the same methods that are also useful for permanently bonding together the first and second sheet members of the tamperproof case of the present invention.

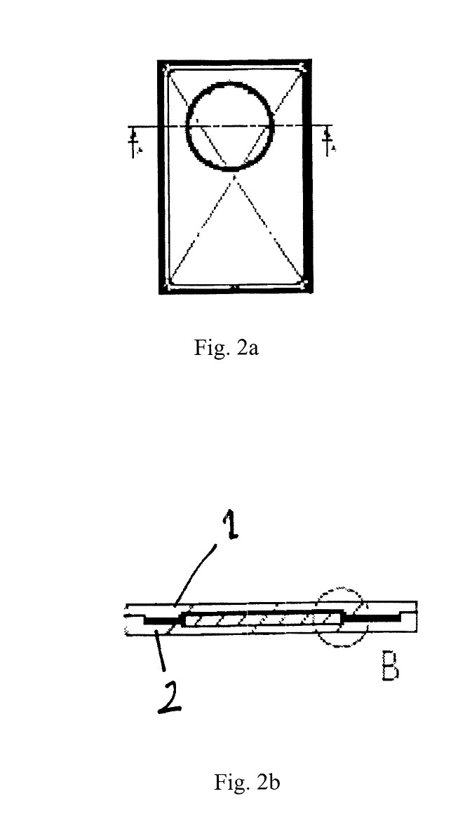

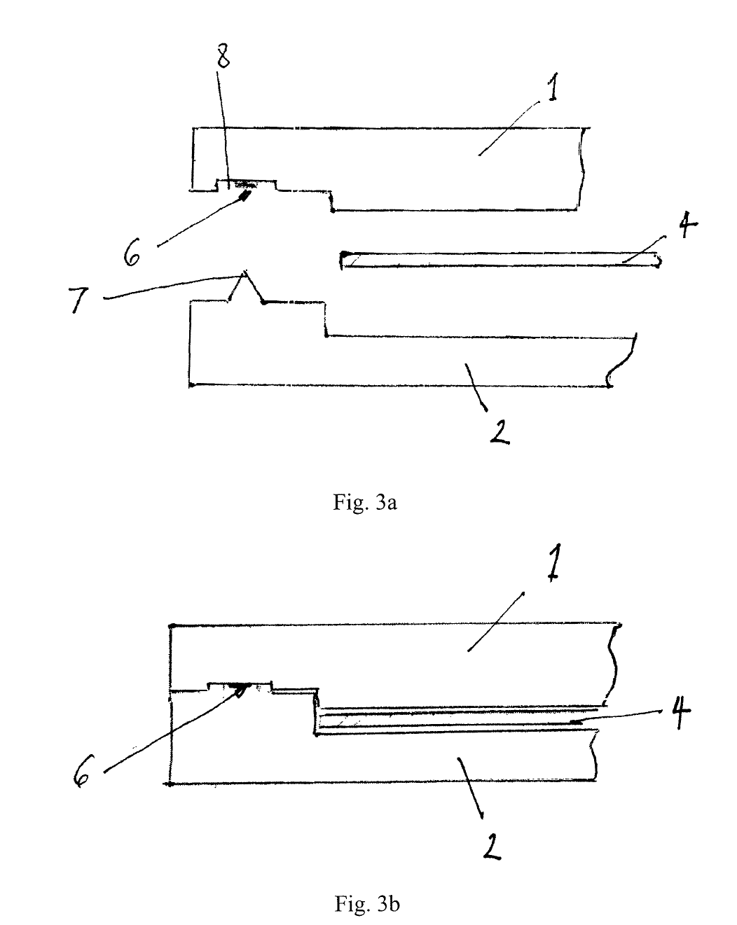

With reference to the drawings, FIG. 1 is an exploded view of one embodiment of a tamperproof case of the present invention that contains a genuine article and a certificate of authenticity. The case comprises first and second sheet members 1 and 2, a coin (e.g., a gold coin) 3 and a certificate of authenticity 4 comprising a hole 5 for inserting the coin 3 therein. FIG. 2a shows a top view and FIG. 2b shows a side view (along the line A-A′ of FIG. 2b) of the embodiment of FIG. 1. FIGS. 3a and 3b show a cross-section of parts of the first and second sheet members 1 and 2 and the certificate of authenticity 4 of the embodiment of FIG. 1 before and after permanent bonding of the first and second sheet members (e.g., by ultrasonic welding). Reference numeral 6 indicates the invisible security element inside a depression 8 along the perimeter of the first sheet member 1 and reference numeral 7 indicates a raised section along the perimeter of the second sheet member 2. The position of the raised section 7 of the second sheet member 2 corresponds to the position of the depression 6 of the first sheet member 1 so that after completion of the permanent bonding operation the depression 8 is substantially completely filled with the material of the raised section 7, thereby permanently sandwiching the invisible security element 6 between the first and second sheet members 1 and 2 along the perimeters thereof.

One advantage of the tamperproof case of the present invention in comparison cases of the prior art is based on the choice of the sheet member according to its thickness and its ability to be compatible with, e.g., an IR and/or UV reader and its compatibility with the use of very small amount of security element detected by the use of IR and/or UV reader. By using this a combination of sheet member plus, e.g., security ink it is nearly impossible for a counterfeiter to at the first glance determine the presence of an invisible security element. Accordingly, if the counterfeiter merely replaces the two sheet members after having broken them by new ones, the government and retailers will know that counterfeiting has taken place (because of the absence of invisible security elements on and/or inside the replacement sheet members).

### EXAMPLE

A typical ink for ink jet printing for uses in the present invention is prepared as follows:

Black with Fluorescent Red (254 nm):

To a solution of deionized water (240 g) are added 2-pyrrolidone (30 g) and 1,2-hexanediol (15 g). The solution is stirred at 500-600 rpm in order to obtain a homogenized solution. 15 g of the complex Na₃[Eu(dpa)₃] (dpa=pyridine dicarboxylate) (or a larger complex such as Na₅[Eu(dpa)₅]) are added to the solution, then heated at 40° C. until the complex is completely dissolved. The resultant solution is cooled to ambient temperature, and the resultant mixture is stirred at 500-600 rpm for about 20 minutes. Thereafter, the solution is filtered to remove all insoluble materials and unreacted products.

The ink obtained by the above procedure is packaged in a HP45 cartridge and used with a Deskjet printer of the 960Cxi, 970Cxi, 980Cxi or 990 Cxi series. Fluorescence at 254 nm is detected using a Fisher Bioblock Scientific VL-4.LC lamp. Droplets of said ink are deposited on one of two sheet members in the zone in which the sheet members are to be permanently bonded together. Thereafter the two sheet members are ultrasonically bonded in order to obtain a tamperproof case. The fluorescence at 254 nm of the security element can be detected in the zone where the two sheet members are bonded together.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A tamperproof case containing a genuine article, wherein the case comprises a space containing the article between first and second sheet members which are permanently bonded together in at least an area that substantially completely surrounds the space, and wherein and least one of (i) at least one of the first and second sheet members comprises at least one security element that is invisible under light in a visible wavelength range, and (ii) at least one security element that is invisible under light in a visible wavelength range is present in the area in which the first and second sheet members are permanently bonded together.

2. The tamperproof case of claim 1, wherein at least one security element that is invisible under light in a visible wavelength range is present in the area surrounding the article in which the first and second sheet members are permanently bonded together.

3. The tamperproof case of claim 1, wherein at least one security element that is invisible under light in a visible wavelength range is present at least one of on and inside at least one of the first and second sheet members.

4. The tamperproof case of claim 1, wherein the case comprises at least two security elements which are invisible under light in a visible wavelength range.

5. The tamperproof case of claim 4, wherein at least one of the at least two security elements is present in the area surrounding the article in which the first and second sheet members are permanently bonded together.

6. The tamperproof case of claim 1, wherein the at least one security element is visible under UV light and at least one of the first and second sheet members is made of a material that is transparent for UV light in at least an area that comprises the security element.

7. The tamperproof case of claim 1, wherein the at least one security element is visible under IR light and at least one of the first and second sheet members is made of a material that is transparent for IR light in at least an area that comprises the security element.

8. The tamperproof case of claim 1, wherein at least one of the first and second sheet members comprises at least one material selected from acrylic resins, methacrylic resins, polyvinyl chloride, and polycarbonate.

9. The tamperproof case of claim 1, wherein the first and second sheet members are permanently bonded together by at least one of ultrasonic welding, laser welding, lamination, crimping and gluing.

10. The tamperproof case of claim 1, wherein the at least one security element comprises one or more of a flake, a dye, a crystal, a polymer, a polymorph, an organic compound, an inorganic compound, a complex compound, a chelate compound, a salt, and nanoparticles.

11. The tamperproof case of claim 1, wherein the at least one security element has been applied in a form of an ink.

12. The tamperproof case of claim 1, wherein the at least one security element is present as at least one of a data matrix, a logo, a character, a barcode, a motif, a pattern, and indicia.

13. The tamperproof case of claim 1, wherein the article is or comprises an article of value selected from at least one of a coin, a medal, an ingot, a gem, a diamond, a pearl, jewelry, a watch, a stamp, a banknote, and an antique or ancient article.

14. The tamperproof case of claim 1, wherein the article is or comprises a foodstuff, a perfume, a cosmetic product, a pharmaceutical, a software storage medium, a computer part, a CD/DVD, or a spare part for an automobile or an appliance.

15. The tamperproof case of claim 1, wherein a certificate of authenticity is present between the first and second sheet members.

16. The tamperproof case of claim 15, wherein the certificate is present in a form of a sheet member.

17. The tamperproof case of claim 15, wherein the certificate comprises a void and the article is at least partially surrounded by the certificate.

18. The tamperproof case of claim 15, wherein the certificate comprises at least one security element that is invisible under light in a visible wavelength range.

19. The tamperproof case of claim 15, wherein the certificate is permanently bonded to the first and second sheet members in at least a part of the area in which the first and second sheet members are permanently bonded together.

20. A tamperproof case for a genuine article, wherein the case comprises a space for accommodating the article between first and second sheet members which are capable of being permanently bonded together in at least an area that substantially completely surrounds the space, and wherein at least one of the first and second sheet members comprises at least one security element that is invisible under light in a visible wavelength range.

21. A method of making a tamperproof case for a genuine article, wherein the method comprises permanently bonding together two sheet members which together provide a space for accommodating the article between the sheet members, the bonding being conducted to not more than to an extent which still allows the article to be placed in the space, and wherein at least one of the first and second sheet members comprises at least one security element that is invisible under light in a visible wavelength range.

22. A method of authenticating a genuine article, wherein the method comprises arranging the article in a space between first and second sheet members, and permanently bonding the first and second sheet members together in at least an area that substantially completely surrounds the space containing the article, at least one of the first and second sheet members comprising at least one security element that is invisible under light in a visible wavelength range.

23. A tamperproof bag containing a genuine article, wherein the bag is permanently sealed or comprises a single opening that is capable of being permanently sealed and comprises at least one security element that is invisible under light in a visible wavelength range.

24. The tamperproof bag of claim 23, wherein the at least one security element is present in an area in which an opening of the bag is permanently sealed or sealable.

25. The tamperproof bag of claim 23, wherein the at least one security element is present inside a material from which the bag is made.
